(19) United States
(12) Patent Application Publication
(10) Pub. No.: US 2026/0087655 A1
(43) Pub. Date: Mar. 26, 2026

(54) Systems and Methods for Processing Image Depth with Camera Poses

(71) Applicant: Hover Inc., San Francisco, CA (US)

(72) Inventor: Manlio Barajas, San Francisco, CA (US)

(73) Assignee: Hover Inc., San Francisco, CA (US)

(21) Appl. No.: 19/338,442

(22) Filed: Sep. 24, 2025

Related U.S. Application Data
(60) Provisional application No. 63/699,803, filed on Sep. 26, 2024.

(51) Int. Cl. G06T 7/33; G06T 7/55; G06T 19/00

(52) U.S. Cl. CPC G06T 7/337; G06T 7/55; G06T 19/00; G06T 2207/10028; G06T 2207/30184; G06T 2207/30244

(57) ABSTRACT

An example provides a method, including: obtaining, using a set of one or more processors, first depth map data and second depth map data derived from respective depth maps generated for different two-dimensional (2D) images of a scene; selecting, using the set of one or more processors, a subset of three-dimensional (3D) points derived from the respective depth maps to adjust one or more of the first depth map data and the second depth map data; and adjusting, using the set of one or more processors, the one or more of the first depth map data and the second depth map data based on the subset of the 3D points selected.

### CROSS-REFERENCE TO RELATED APPLICATIONS

This application claims priority to U.S. provisional patent application Ser. No. 63/699,803, filed Sep. 26, 2024, and having the title “Systems and Methods for Processing Image Depth with Camera Poses,” the entire contents of which are incorporated by reference herein.

### TECHNICAL FIELD

The disclosed implementations generally relate to the technical field of computer vision, and more specifically to depth information for 2D images.

### BACKGROUND

Depth estimation in computer vision has many applications including three dimensional (3D) visualization, 3D modeling, and the like. As a non-limiting example, a user may capture a set of two-dimensional (2D) images of a building's interior or exterior using a single camera that is repositioned as the user walks around the building capturing the 2D images. These 2D images may be transformed into a 3D representation of the scene, allowing for a virtual scene to be constructed and viewed. Such virtual scenes may be used, for example, to provide virtual tours or walkthroughs of a building in an augmented reality (AR) or virtual reality (VR) display.

Monocular depth estimation is a technique that provides depth information from a single 2D image, facilitating building of a 3D scene. In one example, monocular depth estimation assigns each pixel of a 2D image a 3D depth to create a depth map. This can be done, for example, using a machine learning model that is trained to assign depths to the pixels in a 2D image. This depth information permits each 2D image to be converted into a 3D representation of the imaged scene through a process of unprojecting the depth map to form a sparse point cloud. As such, monocular depth estimation has a potential for widespread use in scenarios where more sophisticated equipment (e.g., stereo or active depth sensing technology) is not feasible or desired.

### SUMMARY

Depth data indicating distance from an imager to an object, such as captured in a in a two-dimensional (2D) image or LiDAR, is helpful to generate a three-dimensional (3D) representation of the scene and may be obtained in a variety of ways. For example, 2D image depth maps may be provided directly, e.g., via a monocular depth estimator model, which operates on a 2D image to supply a depth estimate for each pixel using artificial intelligence. These depth maps may be unprojected to form a point cloud, e.g., using camera intrinsics and a camera model to calculate x, y, and z coordinates relative to their respective imager. In an ideal world with no errors each point in the cloud would be a consistent representation of the same points in 3D space, and different point clouds from different 2D images having different points of view or parameters could be combined easily to form a final, dense point cloud from which a 3D representations are formed and used to create various displays, such as augmented reality (AR) or virtual reality (VR) displays. However, there are two main systematic errors that are present: 1) the accuracy of the estimated depth value of each pixel; and 2) the parameters of the imager (such as camera pose accuracy, shutter speed and motion blur, intrinsics estimations, and sensor error such as from the inertial measurement unit (IMU) of a smartphone). These systematic errors or imperfections prevent straightforward creation of dense point clouds from 2D image depth maps.

An embodiment therefore provides methods to intelligently align or register the different point clouds that result from a set of 2D images so they can be combined to form a dense, final point cloud, from which an accurate 3D representation of the scene is made. In an embodiment, subsets of image data useful for adjusting or correcting depth map data, for example as derived via a monocular depth estimator, are identified to improve alignment or registering of the individual point clouds. In an embodiment, one or more techniques are used to compliment a 3D point selection process based on estimated geometric closeness. In an embodiment, the resulting subset of 3D points selected are useful in adjusting depth map data, for example correcting one or more of depth map data and camera pose information.

An embodiment provides a method, comprising: obtaining, using a set of one or more processors, first depth map data and second depth map data derived from respective depth maps generated for different two-dimensional (2D) images of a scene; selecting, using the set of one or more processors, a subset of three-dimensional (3D) points derived from the respective depth maps to adjust one or more of the first-depth map data and the second depth map data; and adjusting, using the set of one or more processors, the one or more of the first depth map data and the second depth map data based on the subset of the 3D points selected.

In an embodiment, the subset of the 3D points comprise one or more landmark pixels (e.g., pixels belonging to a particular predominant object or geometry in a scene) contained in each of the different 2D images. In an embodiment, the adjusting comprises using the landmark pixels to minimize a discrepancy in depth information provided by the one or more of the first-depth map data and the second depth map data.

In an embodiment, the method includes using a scale constraint to bound an update applied to the depth information.

In an embodiment, the first depth map data and the second depth map data each provide a set of 3D points after processing the respective depth maps and the adjusting comprises aligning the set of 3D points based on the subset of the 3D points selected. In an embodiment, the aligning comprises minimizing a distance between two or more of the subset of the 3D points. In an embodiment, the alignment simultaneously minimizes a distance between two or more of the subset of the 3D points and minimizes a distance between covisible landmarks, whether such landmarks'pixels are within the subset of the 3D points.

In an embodiment the selecting comprises using one or more of a normal and a label associated with a pixel of the different two-dimensional (2D) images to identify the subset of the 3D points. In an embodiment, the label is based on a geometry associated with the scene.

In an embodiment, the method comprises generating, based on the aligning, output comprising one or more of, a final point cloud, optimized depth maps, and camera parameters. In an embodiment, the method comprises outputting a final point cloud based on the aligning. In an embodiment, the method comprises outputting an optimized depth map or camera parameters.

In an embodiment the method comprises using the output (e.g., the final point cloud) to form one or more of an augmented reality (AR) and a virtual reality (VR) scene.

In an embodiment, a computer system includes one or more processors, non-transitory computer readable storage medium, and one or more programs stored in the non-transitory computer readable storage medium. The one or more programs are configured for execution by the one or more processors. The one or more programs include instructions for performing any of the methods, or parts thereof, as described herein.

In an embodiment, a non-transitory computer readable storage medium stores one or more programs configured for execution by one or more processors of a computer system. The one or more programs include instructions for performing any of the methods, or parts thereof, as described herein.

The foregoing is a summary and is not intended to be in any way limiting. For a better understanding of the example embodiments, reference can be made to the detailed description and the drawings. The scope of the invention is defined by the claims.

### BRIEF DESCRIPTION OF THE DRAWINGS

FIG. 1 is an example method in accordance with some embodiments.

FIG. 2 illustrates an example of depth maps of a scene in accordance with some embodiments.

FIG. 3 is an example of three-dimensional (3D) points derived from two-dimensional (2D) images of different camera poses, and alignment according to some embodiments.

FIG. 4 illustrates an example of selecting a subset of 3D points according to an embodiment.

FIGS. 5A-5C illustrates an example of selecting points for alignment according to an embodiment.

FIG. 6 illustrates an example of system components according to an embodiment.

### DETAILED DESCRIPTION

Reference will now be made to various embodiments, examples of which are illustrated in the accompanying drawings. In the following detailed description, numerous specific details are set forth in order to provide a thorough understanding of the embodiments and the described implementations. However, the claims may be practiced without these specific details or in alternate sequences or combinations. In other instances, well-known methods, procedures, components, and circuits have not been described in detail so as not to unnecessarily obscure aspects of the embodiments.

As described herein, two-dimensional (2D) image depth map data contains errors due to inherent deficiencies in the process of generating the depth estimates, such as training bias and the inherent inaccuracy of using neural networks. The 2D images on which the depth map information is oriented, is based on camera pose data (e.g., rotation and translation data), which itself may be inaccurate or contain errors, such as the accumulation of drift-based sensor error. Accordingly, when attempting to use depth maps, for example to align or register multiple depth maps and associate pixels from one depth map with another to form a dense point cloud and 3D representation of the scene, these errors are compounded. Thus, while depth maps generated by a monocular depth estimator could provide more direct point clouds that are not subject to a locally inaccurate placement of globally-optimized points (determined for example using structure from motion or bundle adjustment), there still remain errors in the resultant depth maps.

An embodiment provides methods to select a subset of 3D points or associated pixels among a plurality of imagers that are useful in matching to align respective points or correcting depth map data or pose information. In an embodiment, a subset of 3D points and associated depth data are chosen as candidates useful for iteratively adjusting, e.g., correcting, depth estimates of depth maps, camera poses, or both. In an embodiment, pixels associated with landmark objects co-visible in each respective 2D image, are identified, for example via triangulation, and used to determine an initial alignment. In an embodiment, a geometric proximity analysis, such as Iterative Closest Points (ICP) analysis, is used on a select subset of 3D points from unprojected depth map data to assist in refining alignment of unprojected depth map data. In an embodiment, one or more of point normals and semantic labels are used to select the subset of 3D points used for a geometric proximity analysis. In an embodiment, depth map data comprising one or more of pixel depth data and camera pose data are updated or modified iteratively.

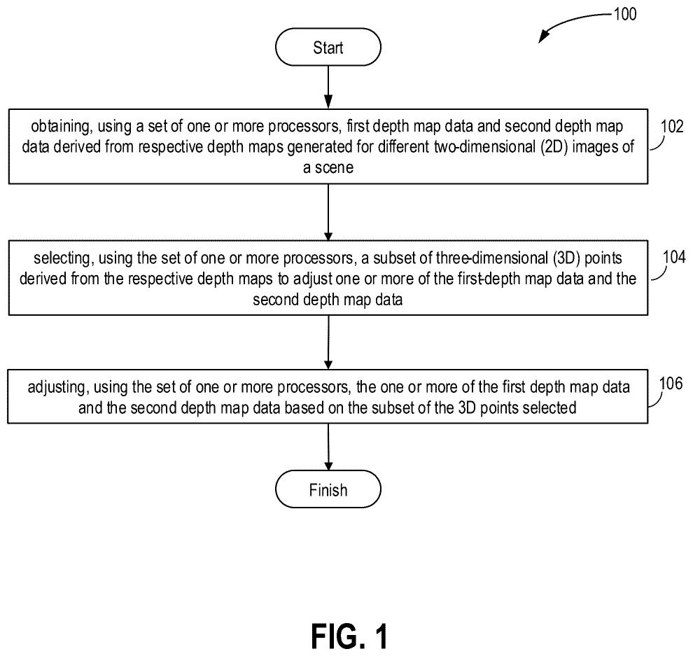

Referring to FIG. 1, an embodiment provides a method 100. As illustrated, method 100 may include obtaining, using a set of one or more processors, first depth map data and second depth map data derived from respective depth maps generated for different 2D images of a scene, indicated at 102. For example, depth information for two or more 2D images taken from different points of view for a scene may be unprojected to generate point clouds, which include depth information, e.g., distance to a 3D object such as a house included in the scene. This depth map data may be generated, for example, by existing models such as monocular depth estimator models including Metric3D, Depth Anything, ZoeDepth, and the like. One of skill in the art will appreciate the techniques described herein with reference to pairs of imagers or their depth maps are applicable for greater numbers and are intended to work with such greater numbers simultaneously. Depictions and references to “first and second” should be interpreted to include “first and second and third simultaneously” and “first and second and third and fourth simultaneously” and so on to any number N of depth maps or images.

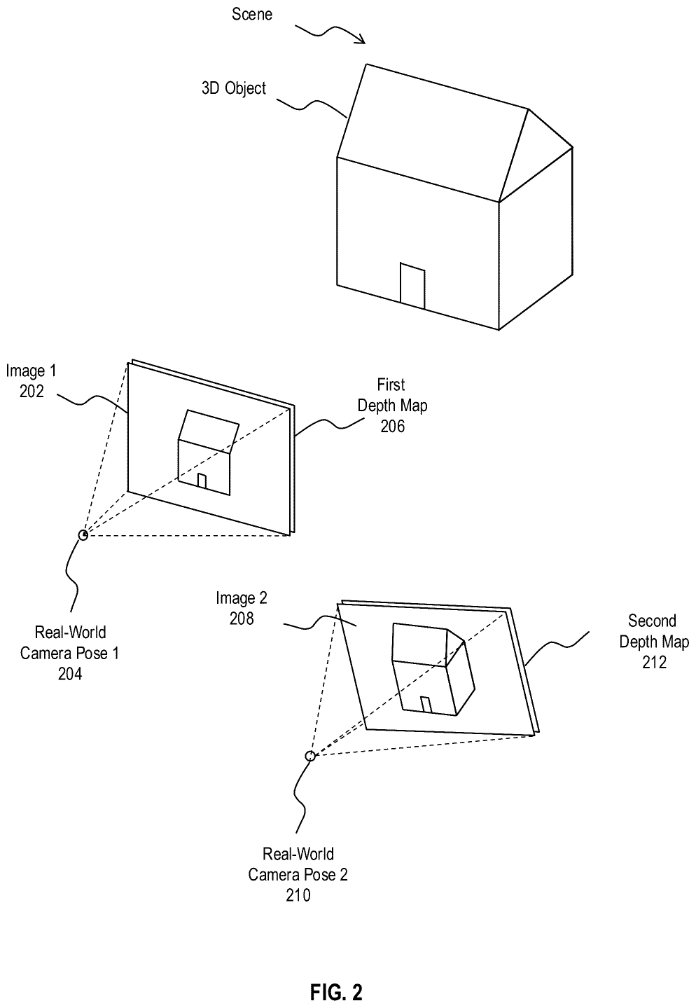

Referring to FIG. 2, by way of example, illustrated is a scene that includes a 3D object such as a house or building. Images such as image 1, 202 and image 2, 208 may be captured by a single imager, e.g., a smartphone camera that is repositioned by a user. These are produced by real-world camera poses 1 and 2, 204 and 210, respectively, as illustrated. The real-world camera poses are points of view of the scene and its 3D object. As such, each 2D image may be used to generate a respective depth map, illustrated in the example of FIG. 2 as first depth map 206 and second depth map 212.

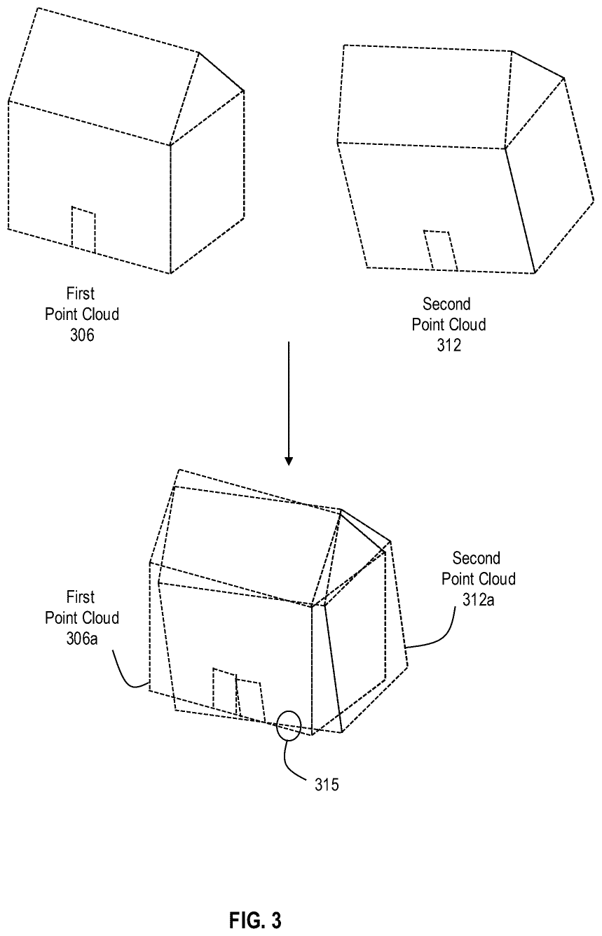

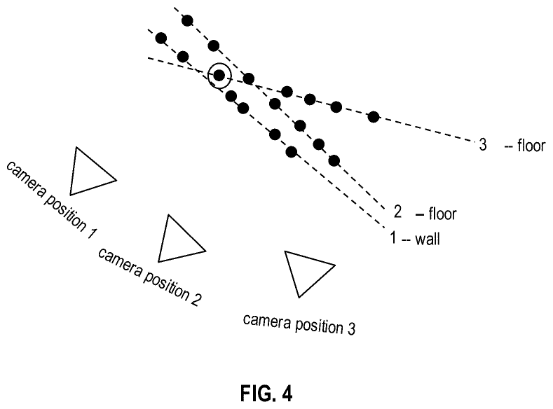

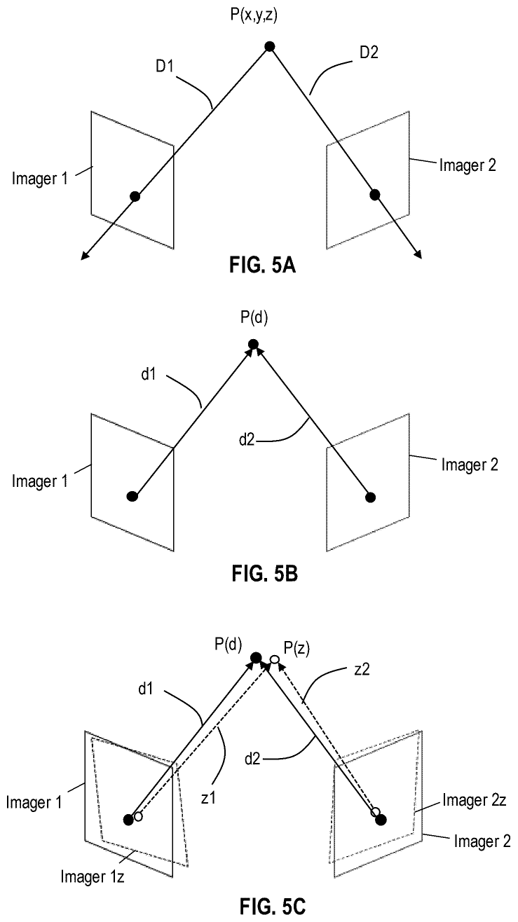

In an embodiment, method 100 may include selecting, using the set of one or more processors, a subset of 3D points derived from the respective depth maps to adjust one or more of the first-depth map data and the second depth map data, indicated at 104. For example, an embodiment may utilize depth maps obtained from respective 2D images and identify a subset of pixels or 3D points useful in adjusting or correcting the depth map data. By way of specific example, an embodiment may choose a subset of pixels by, for example, ensuring points with opposing normal are not selected and only including points with similar semantic labels. In an embodiment, such filtering may be applied using data applied to or associated with the image, e.g., via metadata, such as illustrated in FIG. 3 and FIG. 4. In an embodiment, point normals or semantic labels, or both, may be included in depth map data as part of an automated process, e.g., such as use of a monocular depth estimator model. In an embodiment, landmarks may be used to select pixels, e.g., initial pixels useful in minimizing depth data and creating an initial alignment of unprojected depth map data, with updated points enabling refined camera poses, as illustrated in connection with FIGS. 5A-5C. In this way, RGB image data (e.g., from a landmark) may be used to adjust corresponding depth values in a depth map associated with the RGB image.

Referring to FIG. 3, an embodiment may perform a geometric proximity technique on a select subset of 3D points rather than on a pure geometric proximity basis. For example, FIG. 3 illustrates a first point cloud 306 and a second point cloud 312, each of which are respectively obtained by unprojecting a 2D image's depth map. As described herein, existing models may be utilized to generate such point clouds. As illustrated in FIG. 3, these point clouds are not aligned, such as from lack of accurate initial camera pose information, e.g., due to accumulation of sensor error, such as IMU drift. Further, as described, the depth map data may include an inaccurate depth estimate, e.g., due to model bias and inherent inaccuracies from the scene (such as the presence of reflective surfaces) or neural network model.

As shown in FIG. 3, where ideal data would permit one to align or register each point in the respective point clouds 306 and 312 with one another, the inclusion of the error in the data as described herein results in misalignment between these points even after the point of view is corrected, as illustrated in the lower portion of FIG. 3 for processed first point cloud 306a and second point cloud 312a.

To compensate for the noise or error underlying any one data set, e.g., in one or more of point cloud 306 or 312, in some embodiments a series of camera pose corrections and depth map corrections is implemented. While a naïve approach may be to adjust the information for any one image (either its depth map, pose, or both) a vast amount of ground truth data is needed to accurately correct the errors, and may conflict with multiview consistency for common points. In other words, given perfect information of the world, any one noisy image for a pose or predicted depth information may be corrected using the known data. In the absence of sufficient ground truth data, such a single camera adjustment is prone to compounded errors by not being able to confirm any adjustment.

To operate with insufficient ground truth data, in some embodiments global adjustments to the data are applied, simultaneously adjusting the depth of a pixel (as by using the location of that pixel in other depth map(s)) and the pose information. Note that adjusting only one of the pose information or the depth data imputes the noise of one constraint into the other.

In some embodiments, points for performing iterative adjustments, such as a subset of 3D points identified as geometrically close, proximate or relevant, are identified. As such, an embodiment attempts to intelligently select a subset of pixels to use. For example, as illustrated in FIG. 3, a subset of 3D points 315 may be selected for use in adjustments based on one or more factors, such as sharing an association with a geometric feature of the 3D object or scene, sharing point normals that are not opposed according to a threshold, etc.

Referring to FIG. 4, even though a depth pixel of one depth map may be geometrically proximate to another depth point of another depth map, iterative adjustment of the pixels'depth and position as a function of camera pose are not made unless the pixels share a semantic label or similar normal vector direction. This prevents false matches among points that may otherwise appear to be geometrically close to one another. In some embodiments, an iterative adjustment comprises adjusting a depth map value, such as by an affine transformation of depth scale and bias (or offset). In some embodiments, an adjustment to a single depth map value is propagated to all other depth map values of such depth map.

In some embodiments, an artificial geometry is created to fit an unprojected collection of points, e.g., from first point cloud 306 and second point cloud 312, and only depth pixels proximate to or sharing a semantic label with the artificial geometry are leveraged to align the point clouds. In this way, given a plurality of points to match, points closer to the artificial geometry are eligible for use in matching even if there is another point closer to the depth pixel in question because the otherwise closer pixel would be further from the artificial geometry than another candidate point.

In some embodiments, a semantic segmentation is performed on the RGB data for an image or its depth values, such labelling certain regions as planar elements like floor, ceiling or wall. Unprojected depth points across multiple depth maps belonging to a common planar classification may be constrained during optimization or iterative adjustments to maintain planar relationship consistent with the given classification. For example, unprojected depth values belonging to a floor class may be constrained to maintain a common floor height relative to other depth values of such classification in the same and other depth maps.

In some embodiments, iterative adjustments are limited to single targets across depth maps. In this way, even though a depth map may have a plurality of unprojected depth points, only a single unprojected depth point per frame may be used for iterative adjustments. In some embodiments, a plurality of unprojected depth points across the multiple depth maps are used for iterative adjustments.

As illustrated in FIG. 4, a circled depth pixel (associated with depth map 3 produced by the frame having camera position 3) has several possible target depth pixels to potentially match under a proximity analysis, for example ICP, according to depth pixels from depth maps 1 and 2. In some embodiments, matching the circled depth pixel is limited to a single target depth pixel from another depth map, target depth pixels from another depth map that share a semantic label, target depth pixels from another depth map that share a normal vector direction, or combinations of the foregoing. In some embodiments, an optimization for any one depth map is made by iteratively minimizing differences among depth maps using a transformation (e.g., an affine transformation for depth values'scale and bias (or offset)) applied to each depth map.

In some embodiments, method 100 therefore comprises labelling the set of 3D points based on a category, for example the type of object a point is aligned with. The selecting at 104 comprises using the label to identify the subset of the 3D points. In an embodiment, the label is based on a geometry associated with the scene. For example, an embodiment may label 3D points with semantic labels associated with scene geometry, for example as inclusive of object subparts identified via a segmentation process. By way of specific example, the labels may be related to an interior or exterior of a building, such as a floor, a ceiling, a corner, or the like. In an embodiment, the labels may be based on a modeled geometry, e.g., an interior or exterior model of a building.

Referring to FIG. 4, in an embodiment labels such as floor and wall applied to depth maps 1, 2 and 3 may be used to assist or guide in the selection of a subset of points, e.g., a circled point of depth map 3 may be matched with a point of depth map 2, even though a point of depth map 1 may be geometrically closer. This may be used to guide an alignment process, such as ICP, that relies on pairs of points to iteratively update one or more of depth information and pose information as part of an update pipeline.

In an embodiment, and referring to FIGS. 5A-5C, 3D points may be selected using landmarks to perform an initial alignment of 2D image data. In some embodiments, the pixels of a depth map are matched according to such use of landmark pixels, wherein a landmark pixel may be triangulated according to image coordinates or by structure from motion or other image matching techniques. Though depth map pixels may be dense (i.e. a depth estimate is provided for every pixel), landmark pixels may be co-visible features among frames. Using bundle adjustment, a pose may be corrected relative to a plurality of images at different poses, thus enabling a frame to have a reliable position for each of the landmark pixels. The triangulated landmark pixel may then be compared to the corresponding depth map at such pixel, as shown and described in connection with FIGS. 5A-5C.

As shown in FIG. 5A, the landmark point P has a triangulated position (x,y,z), as triangulated from the two imagers and their respective image planes (imager 1 and imager 2) has a position in 3D space, with the depth of such point denoted as D1 and D2 from each of imager 1 and imager 2, respectively. Additionally, that same point P may have a predicted depth map value of d1 and d2 from each of imager 1 and imager 2, respectively as shown in FIG. 5B. In some embodiments, the position of the pixel associated with point P (illustrated as pixel P(d)) is adjusted to minimize a difference between d1 to D1 or d2 to D2, as illustrated in FIG. 5C. In some embodiments, a minimization is performed to generate new relative error and bias offset values for the respective depth maps, at least with respect to such point P.

As depth discrepancies are minimized, however, a landmark position should correspondingly adjust, illustrated as moving from position P(d) in FIG. 5B to position P(z) in FIG. 5C to better match the minimized depth discrepancies. Accordingly, the (x,y) coordinates of that same point shifts in an imager's image plane, and the respective imager's pose information is adjusted to fit the new z-value for the point (z1, z2), thus modifying the imagers' poses from imager 1 to imager 1z and imager 2 to imager 2z respectively. Note that continually adjusting the pose to a minimum depth, or minimizing depth discrepancies and adjusting the pose, will degenerate by shrinking the point cloud into a sphere of zero size. To protect against this, some embodiments use pose adjustments or scale adjustments which are fixed and may not change too far beyond their original pose or depth estimates. In some embodiments, a scaling constraint, such as a maximum threshold percentage change per iteration, is used.

Referring to FIG. 1, method 100 may include adjusting, using the set of one or more processors, the one or more of the first depth map data and the second depth map data based on the subset of the 3D points selected, indicated at 106. In an embodiment, the adjusting depth map data may comprise adjusting camera pose. In an embodiment, the adjusting comprises using identified landmark pixels to minimize a discrepancy in depth information provided by the one or more of the first depth map data and the second depth map data. In an embodiment, the method includes using a scale constraint to limit updates applied to the one or more of the first-depth map data and the second depth map data.

In an embodiment, the first depth map data and the second depth map data each provide a set of 3D points after processing the respective depth maps and the adjusting comprises aligning the set of 3D points based on the subset of the 3D points selected. In an embodiment, the aligning comprises minimizing a distance error between two or more of the subset of the 3D points.

In an embodiment, adjusting at 106 includes an iterative process. In an embodiment, an iterative depth-estimate informed pose change functions as a form of bundle adjustment itself for pose predictions of an imager, while working in reverse as well to create a bundle adjustment informed depth estimate. In an embodiment, when initial depth maps and initial poses have been adjusted according to the techniques described herein, and depth pixels eligible for use as a subset, e.g., using ICP, the process applied on the filtered subset of 3D data points produces a more cohesive un-projected point cloud of depth points.

Thus, disclosed are improved techniques for identifying points for, and managing identified points by, a process that updates one or more of depth map data and camera pose data, e.g., using ICP analysis to align a plurality of un-projected depth maps, to produce 3D representations of capture scenes.

In an embodiment, the method comprises outputting a final point cloud, e.g., based on the aligning of depth map data comprising the subset of 3D points. In an embodiment the method comprises using the final point cloud to form one or more of an augmented reality (AR) and a virtual reality (VR) scene. In an embodiment, the method comprises producing updated depth map data, e.g., adjusted according to an iterative process as described herein.

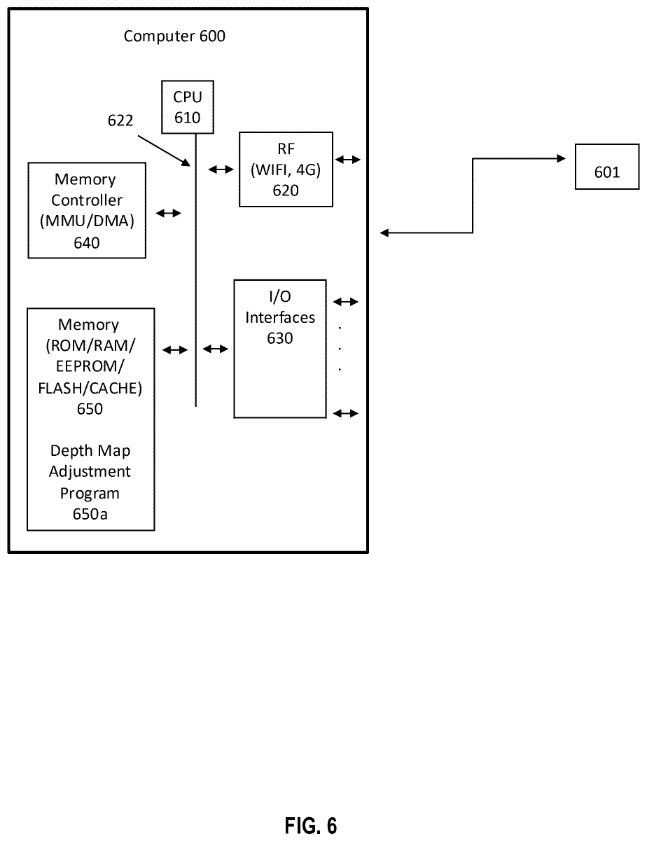

It will be readily understood that certain embodiments can be implemented using any of a wide variety of devices or combinations of devices. Referring to FIG. 6, an example device that may be used in implementing one or more embodiments includes a computing device (computer) 600, for example that communicates with an imaging device or imager 601.

Computer 600 may execute program instructions or code configured to obtain, store and process sensor data (e.g., images and related data from imaging device 601, etc.) and perform other functionality of the embodiments. Components of computer 600 may include, but are not limited to, a processing unit 610, which may take a variety of forms such as a central processing unit (CPU), a graphics processing unit (GPU), a combination of the foregoing, etc., a system memory controller 640 and memory 650, and a system bus 622 that couples various system components including the system memory 650 to processing unit 610. The computer 600 may include or have access to a variety of non-transitory computer readable media. The system memory 650 may include non-transitory computer readable storage media in the form of volatile and/or nonvolatile memory devices such as read only memory (ROM) and/or random-access memory (RAM). By way of example, and not limitation, system memory 650 may also include an operating system, application programs, other program modules, and program data. For example, system memory 650 may include application programs such as depth map adjustment program 650a, such as a software program for performing some or all of the steps illustrated the figures included herewith. Data may be transmitted by wired or wireless communication, e.g., to or from imaging device or imager 601 to another computing device, e.g., a remote device or system, such as a customer device that consumes image processing, model data or other outputs in the nature of a report update, AR or VR display, as described herein.

A user can interface with (for example, enter commands and information) computer 600 through input devices such as a touch screen, keypad, etc. A monitor or other type of display screen or device can also be connected to the system bus 622 via an interface, such as interface 630. Computer 600 may operate in a networked or distributed environment using logical connections to one or more other remote computers or databases. The logical connections may include a network, such local area network (LAN) or a wide area network (WAN) but may also include other networks/buses.

It should be noted that various functions described herein may be implemented using processor executable instructions stored on a non-transitory storage medium or device. A non-transitory storage device may be, for example, an electronic, electromagnetic, or semiconductor system, apparatus, or device, or any suitable combination of the foregoing. More specific examples of a non-transitory storage medium include the following: a portable computer diskette, a hard disk, a random-access memory (RAM), a read-only memory (ROM), an erasable programmable read-only memory (EPROM or Flash memory), a portable compact disc read-only memory (CD-ROM), a solid-state drive, or any suitable combination of the foregoing. In the context of this document “non-transitory” media includes all media except non-statutory signal media.

Program code embodied on a non-transitory storage medium may be transmitted using any appropriate medium, including but not limited to wireless, wireline, optical fiber cable, RF, etc., or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), a personal area network (PAN) or the connection may be made through other devices (for example, through the Internet using an Internet Service Provider), through wireless connections, or through a hard wire connection, such as over a USB or another power and data connection.

Example embodiments are described herein with reference to the figures, which illustrate various example embodiments. It will be understood that the actions and functionality may be implemented at least in part by program instructions. These program instructions may be provided to a processor of a device to produce a special purpose machine, such that the instructions, which execute via a processor of the device implement the functions/acts specified.

It is worth noting that while specific elements are used in the figures, and a particular illustration of elements has been set forth, these are non-limiting examples. In certain contexts, two or more elements may be combined, an element may be split into two or more elements, or certain elements may be re-ordered, re-organized, combined or omitted as appropriate, as the explicit illustrated examples are used only for descriptive purposes and are not to be construed as limiting.

As used herein, the singular “a” and “an” may be construed as including the plural, i.e., “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting, and that various other changes and modifications may be affected therein by one skilled in the art without departing from the scope or spirit of the disclosure.

What is claimed is:

1. A method, comprising:
obtaining, using a set of one or more processors, first depth map data and second depth map data derived from respective depth maps generated for different two-dimensional (2D) images of a scene;
selecting, using the set of one or more processors, a subset of three-dimensional (3D) points derived from the respective depth maps to adjust one or more of the first depth map data and the second depth map data; and
adjusting, using the set of one or more processors, the one or more of the first depth map data and the second depth map data based on the subset of the 3D points selected.

2. The method of claim 1, wherein the subset of the 3D points comprise one or more landmark pixels contained in each of the different 2D images.

3. The method of claim 2, wherein the adjusting comprises using the landmark pixels to minimize a discrepancy in depth information provided by the one or more of the first-depth map data and the second depth map data.

4. The method of claim 3, comprising using a scale constraint to an update applied to the one or more of the first-depth map data and the second depth map data.

5. The method of claim 1, wherein:
the first depth map data and the second depth map data each provide a set of 3D points after processing the respective depth maps; and
the adjusting comprises aligning the set of 3D points based on the subset of the 3D points selected.

6. The method of claim 5, wherein the aligning comprises minimizing a distance between two or more of the subset of the 3D points.

7. The method of claim 6, wherein the selecting comprises using one or more of a normal and a label associated with a pixel of the different two-dimensional (2D) images to identify the subset of the 3D points.

8. The method of claim 7, wherein the label is based on a geometry associated with the scene.

9. The method of claim 5, comprising generating, based on the aligning, output comprising one or more of, a final point cloud, optimized depth maps, and camera parameters.

10. The method of claim 9, comprising using the output to form one or more of an augmented reality (AR) and a virtual reality (VR) scene.

11. A system, comprising:
one or more processors; and
a non-transitory computer readable storage medium having one or more programs executable by the one or more processors and configurable for:
obtaining first depth map data and second depth map data derived from respective depth maps generated for different two-dimensional (2D) images of a scene;
selecting a subset of three-dimensional (3D) points derived from the respective depth maps to adjust one or more of the first depth map data and the second depth map data; and
adjusting the one or more of the first depth map data and the second depth map data based on the subset of the 3D points selected.

12. The system of claim 11, wherein the subset of the 3D points comprise one or more landmark pixels contained in each of the different 2D images.

13. The system of claim 12, wherein the adjusting comprises using the landmark pixels to minimize a discrepancy in depth information provided by the one or more of the first depth map data and the second depth map data.

14. The system of claim 13, comprising using a scale constraint to bound an update applied to the one or more of the first depth map data and the second depth map data.

15. The system of claim 11, wherein:
the first depth map data and the second depth map data each provide a set of 3D points after processing the respective depth maps; and
the adjusting comprises aligning the set of 3D points based on the subset of the 3D points selected.

16. The system of claim 15, wherein the aligning comprises minimizing a distance between two or more of the subset of the 3D points.

17. The system of claim 16, wherein the selecting comprises using one or more of a normal and a label associated with a pixel of the different two-dimensional (2D) images to identify the subset of the 3D points.

18. The system of claim 17, wherein the label is based on a geometry associated with the scene.

19. The system of claim 18, wherein the geometry associated with the scene includes one or more of a corner, a wall, a plane and a floor.

20. A computer program product, comprising:
a non-transitory computer readable storage medium having one or more programs executable by one or more processors and configurable for:
obtaining first depth map data and second depth map data derived from respective depth maps generated for different two-dimensional (2D) images of a scene;
selecting a subset of three-dimensional (3D) points derived from the respective depth maps to adjust one or more of the first depth map data and the second depth map data; and
adjusting the one or more of the first depth map data and the second depth map data based on the subset of the 3D points selected.
